(19) United States
(12) Patent Application Publication
(10) Pub. No.: US 2018/0376237 A1
(43) Pub. Date: Dec. 27, 2018

(54) FREQUENCY-SELECTIVE SILENCING DEVICE OF AUDIBLE ALARMS

(71) Applicant: Vanderbilt University, Nashville, TN (US)

(72) Inventors: Joseph J. Schlesinger, Nashville, TN (US); Brittany Sweyer, Nashville, TN (US); Alyna Pradhan, Nashville, TN (US); Elizabeth Reynolds, Nashville, TN (US)

(21) Appl. No.: 16/011,566

(22) Filed: Jun. 18, 2018

Related U.S. Application Data
(60) Provisional application No. 62/522,995, filed on Jun. 21, 2017.

(51) Int. Cl. H04R 1/10; H04R 5/033

(52) U.S. Cl. CPC H04R 1/1083; H04R 5/033; H04R 1/1016

(57) ABSTRACT

A device for frequency-selective silencing of medical device alarms. The device removes the alarm sounds present in the environment while transmitting other sounds to the patient without distortion. This allows patients to hear everything occurring around them and to communicate effectively without experiencing the negative consequences of audible alarms. The device includes a housing, a microphone, a controller, a filter, and an output circuit. The controller receives the environmental sound including a plurality of frequencies, determines whether a frequency associated with the audible medical alarm is one of the plurality of frequencies in the environmental sound, applies the filter for filtering the frequency associated with the audible medical alarm to the environmental sound, and outputs a filtered version of the environmental sound to a user.

### CROSS-REFERENCE TO RELATED APPLICATIONS

This application is a non-provisional of and claims benefit of U.S. Provisional Application No. 62/522,995, filed on Jun. 21, 2017, the contents of which are incorporated herein by reference.

### BACKGROUND OF THE INVENTION

Free-field auditory medical alarms, although widely present in intensive care units (ICUs), have created many hazards for both patients and clinicians in this environment. The harsh characteristics of the alarm noise profile combined with the frequency at which they sound throughout the ICU have created discomfort for the patients and contribute to psychological problems, such as Post-Traumatic Stress Disorder (PTSD) and delirium. Patients do not need to hear these alarms as the alarms primarily serve to alert clinicians.

Significant issues plaguing successful patient recovery in Intensive Care Units (ICUs) include the frequent occurrence of clinical alarms and the harsh, shrill noises that generally characterize these sounds. Alarms sound frequently to alert clinicians of physiologic aberrancy that exceeds a threshold. However, many alarms have low positive predictive value, meaning that there are high rates of false positives indicated by alarms. As stated by Edworthy et al., multi-parameter auditory warnings may be combined to create varying degrees of urgency. Although the utilization of these results has proven useful to alert clinicians of possible danger, the potential negative consequences from the piercing alarm sounds were not considered from the patient perspective. These alarms have been responsible for numerous negative consequences for both patients and physicians in the ICU. While clinicians may suffer from alarm fatigue and desensitization, the patient-specific consequences are of the utmost concern, as patients commonly experience Post Traumatic Stress Disorder (PTSD) anchored to critical illness and delirium after a stay in the ICU, as assessed by the Clinician-Administered PTSD Scale for DSM-5 (CAPS-5) and the Confusion Assessment Method for the ICU (CAM-ICU), respectively. According to Wade et al., 88% of the ICU patients interviewed experienced hallucinatory/delusional intrusive memories related to ICU care for up to 8 months after hospital discharge. These memories were not factual but rather were fabricated memories or ideas that may have been based on or influenced by experiences in the ICU. Additionally, Pandharipande et al. found that prior to ICU admission, only 6% of patients showed evidence of mild-to-moderate cognitive impairment. After discharge from the ICU, this number increased to 25% of patients.

While the underlying causes of these disorders are not determined, the frequent, loud noises produced by clinical alarms often wake patients in the middle of the night, disturb their sleep patterns, and sound for extended lengths of time with no healthcare provider explanation to the patient regarding the reason behind the alarm. In work from Lutter et al., 67.2% of the alarms from three different machines in the ICU were false positives. These situations may be incredibly disorienting for patients and may potentially contribute to psychological problems after discharge from the ICU. Furthermore, the fact that false alarms are so prevalent further justifies the fact that false alarms cause an unnecessary amount of noise exposure in the ICU environment. If the alarm sounds are not detected by the patient, the likelihood of developing these psychological disorders may be reduced. Patients do not need to hear alarms in these environments. The information conveyed by medical equipment is to signal to physicians and nurses to act, but patients themselves do not need to hear the harsh and shrill tones that occur with free-field audible medical alarms.

### SUMMARY OF THE INVENTION

Given the importance of alarms, it is not surprising that they are ubiquitous and used liberally, and the ‘better-safe-than-sorry’ approach can lead to other problems. For example, conventional beliefs and, often, guidelines on alarm signal implementation hold that alarms must be louder than background (ambient) noise levels in order to be adequately perceived.

Available guidance on the design and evaluation of auditory alarms in fact takes validated models of the auditory filter and demonstrates how the levels of the individual components of auditory alarm signals should be adjusted or designed to be within an appropriate audibility band given the background noise over which it is intended to be heard. Thus, the audibility of an alarm sound doesn't depend just on the overall background noise level, but the spectrum of the background noise and its relationship to the spectrum of the alarm signal.

However, practice has not typically followed in that a) many auditory signals still in use do not possess many frequency components, and may possess only one or two which are much louder than the others, on which its entire audibility relies and b) the take-home message of the earlier, detailed work (that alarms should overall be louder than their background noise, by a considerable margin) leads to alarms which are too loud, by virtue of point a.

This ubiquitous but untested assumption regarding alarm volume relative to background noise has created a vicious cycle of increasing sound intensity, particularly in the less well controlled sound environments, resulting in increased alarm-related incidents. Alarm fatigue, another aspect of alarms and alarm signals which is often talked about but is not well understood in terms of its components, is generally conceived of as desensitization to alarms resulting from the number of audible alarms and associated noise load. Alarm fatigue is also believed to be a factor in many missed or delayed responses. Further, the increased noise from numerous alarms can also increase operator stress, hamper decision-making, predispose to miscommunication, and may have negative health effects including hearing damage and even cardiovascular morbidity from chronic increases in sympathetic tone.

More basically, it is known that unnecessary noise increases stress and reduces performance, so any measures which can reduce noise levels will be beneficial. Embodiments of the invention address the issue as to how loud an auditory alarm signal actually needs to be in order to be detected relative to background noise, in order that the relationship between the alarm and the background noise can be re-conceptualized. For example, what (misinterpreted) guidelines might suggest is that alarms thought to be inaudible might actually be audible, and if set at the level suggested in the (misinterpreted) guidance, they might be so loud as to start interfering with performance.

Therefore, embodiments described herein seek to attenuate these problems by removing the alarm sounds from the patient perspective. In particular, embodiments described herein, using a Raspberry Pi and digital filters, remove the alarm sounds present in the environment while transmitting other sounds to the patient without distortion. This allows patients to hear everything occurring around them and to communicate effectively without experiencing the negative consequences of audible alarms.

Accordingly, embodiments described herein relate to a frequency-selective silencing device for digital filtering of audible medical alarm sounds. For example, one embodiment provides a frequency-selective silencing device for digital filtering of an audible medical alarm sound. The device includes a filter for filtering a frequency associated with the audible medical alarm. The device also includes a detector configured to receive an environmental sound including a plurality of frequencies. The detector is also configured to apply the filter for filtering the frequency associated with the audible medical alarm to the environmental sound and output a filtered version of the environmental sound to a user.

Another embodiment provides a method for silencing an audible medical alarm with a frequency-selective silencing device for digital filtering of the audible medical alarm. The method includes receiving an environmental sound including a plurality of frequencies. The method also includes determining whether the frequency associated with the audible medical alarm is included in the plurality of frequencies. In response to determining the frequency associated with the audible medical alarm is included in the plurality of frequencies, the method also includes applying the filter for filtering the frequency associated with the audible medical alarm to the environmental sound and outputting a filtered version of the environmental sound to a user.

In one embodiment, the invention provides a frequency-selective silencing device for digital filtering of an audible medical alarm. The device comprises a microphone configured to detect environmental sound, a frequency filter, and a controller in communication with the microphone and the frequency filter. The controller is configured to receive the environmental sound including a plurality of frequencies, determine whether a frequency associated with the audible medical alarm is one of the plurality of frequencies in the environmental sound, apply the filter for filtering the frequency associated with the audible medical alarm to the environmental sound, and output a filtered version of the environmental sound to a user.

In another embodiment, the invention provides a method for silencing an audible medical alarm with a frequency-selective silencing device for digital filtering of the audible medical alarm. The method comprises detecting an environmental sound including a plurality of frequencies, determining whether the frequency associated with the audible medical alarm is included in the plurality of frequencies, in response to determining that the frequency associated with the audible medical alarm is included in the plurality of frequencies, applying a filter to filter the frequency associated with the audible medical alarm to the environmental sound, and outputting a filtered version of the environmental sound to a user.

Other aspects of various embodiments will become apparent by consideration of the detailed description and accompanying drawings.

### BRIEF DESCRIPTION OF THE DRAWINGS

FIG. 1 illustrates a frequency-selective silencing device according to an embodiment of the present invention.

FIG. 2 illustrates a block diagram of the frequency-selective silencing device shown in FIG. 1.

FIG. 3 graphically illustrates an alarm audio signal and an OR noise signal.

FIG. 4 graphically illustrates a Fast Fourier Transform of unfiltered real-time audio output containing speech and alarm sounds.

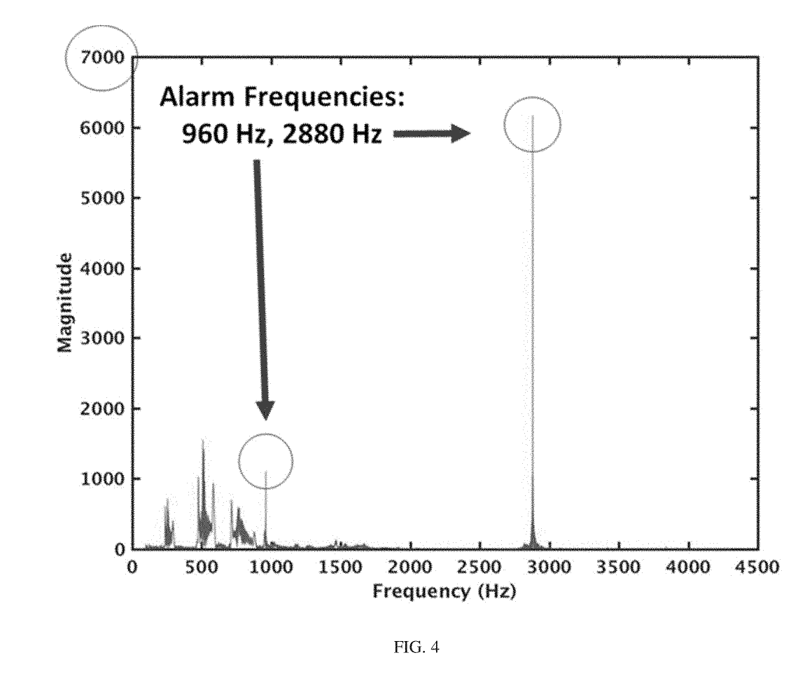

FIG. 5 graphically illustrates a Fast Fourier Transform of real-time audio output with speech and filtered alarm sounds.

FIG. 6 graphically illustrates improved phoneme and word scores with alarm filtering.

FIG. 7 graphically illustrates a Fast Fourier Transform of a single unfiltered alarm.

FIG. 8 graphically illustrates a Fast Fourier Transform of the same alarm of FIG. 7 filtered by a series of bandstop filters.

FIG. 9 graphically illustrates a Fast Fourier Transform of unfiltered real-time audio output with speech and alarm sounds.

FIG. 10 graphically illustrates a Fast Fourier Transform of real-time audio output with speech and filtered alarm sounds.

FIG. 11 graphically illustrates the spectrum of a Philips MR-70 high acuity alarm at three SNR levels relative to the noise background (+4 dB, −11 dB and −27 dB).

FIG. 12 illustrates the study configuration inside the anechoic chamber. The study's experimental paradigm included three interleaved tasks—the primary task was the correct treatment response based on the physiological vital signs presented on a visual display. The participants also had to respond to a visual distractor task and an auditory distractor task, the Coordinate Response Measure (CRM). Pre-recorded discipline-relevant background noise was played through speakers at 60 dB located 15° and 105° left, and 60° and 150° right of the participant's facing direction. There were five alarm SNRs and four types of emergency events. The participant was instructed to respond with equal urgency to all three tasks.

FIG. 13 illustrates the primary task efficiency is preserved down to −11 dB below background noise levels. The model-estimated effect of alarm SNR in dB on the likelihood of correctly and rapidly treating the presented clinical event depicted as the average inverse efficiency score (IES=average response time/accuracy [lower is better]). Shaded regions represent model-based pointwise 95% confidence bands under the conditions when there was or was not a concurrent distracting auditory (CRM) task. The plotted points are raw averages of individual IES values with 95% confidence interval. The CRM task significantly degraded performance accuracy.

FIG. 14 illustrates the secondary auditory task accuracy deteriorated at typical alarm SNRs. The model-estimated effect of alarm signal-to-noise ratio (SNR) on the likelihood of correctly responding to the Coordinate Response Measure (CRM) secondary auditory task. Shaded regions represent model-based pointwise 95% confidence bands under the conditions when there was and was not a concurrent distracting visual vigilance task. The plotted points are the raw averages of individual accuracies (i.e., correctly addressed CRM tasks) with 95% confidence interval. Secondary task accuracy deteriorated at the highest alarm SNR (i.e., 4 dB above background, which is typical of real-world situations).

FIG. 15 illustrates the secondary auditory task response time was not affected by alarm SNR. The alarm signal-to-noise ratio (SNR) in decibels (dB) did not significantly affect the response time to the Coordinate Response Measure (CRM) secondary auditory task. Shaded regions represent model-based pointwise 95% confidence bands for mean response time under the conditions when there was and was not a concurrent distracting visual vigilance task. The plotted points are the raw averages of individual mean response times with 95% confidence interval. The occurrence of a visual vigilance task did not significantly affect response time.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

In some embodiments, the invention contemplates complete avoidance of free-field alarms by transmitting signals directly to in-ear devices worn by physicians and nurses that correspond to the patients to whom they are specifically attending. The embodiments described herein may provide an interim solution and help alleviate the problems experienced by the patients.

Embodiments described herein expand on the concept of avoiding unnecessary alarms in already busy and noisy hospital settings. This is accomplished by the creation of a patient wearable device for frequency-selective silencing. The device operates to silence the frequencies corresponding to the alarm noises (primarily patient monitor red/crisis alarm) and will allow the passage of all normal sounds (speech and other environmental stimuli), while maintaining their quality to reduce the likelihood of delirium.

The device is user-friendly and comfortable to allow for continuous patient wear, especially while the patient is asleep. Additionally, the device may reduce the occurrence of PTSD and delirium in the ICU by blocking alarm sounds while allowing the passage of all other environmental noise, such as speech and TV sounds. It is important to note that overstimulation of the auditory sense as well as a complete lack of stimulation of the auditory sense can contribute to PTSD and delirium, which is why noise-cancelling headphones and/or simple earplugs that dampen all environmental noise entirely may not be the desired solution.

Keeping this in mind, the device should not muffle or distort any normal environmental sounds as this may lead to negative consequences for the patient. This also suggests that the device process environmental noise in real-time because a noticeable delay may also contribute to psychological distress for the patient. The device may also be equipped with a detection method so that the filtering system is only activated when an alarm noise is present in the environment. By including this feature, the likelihood of unnecessarily distorting speech may be reduced and ICU-induced PTSD may further be avoided.

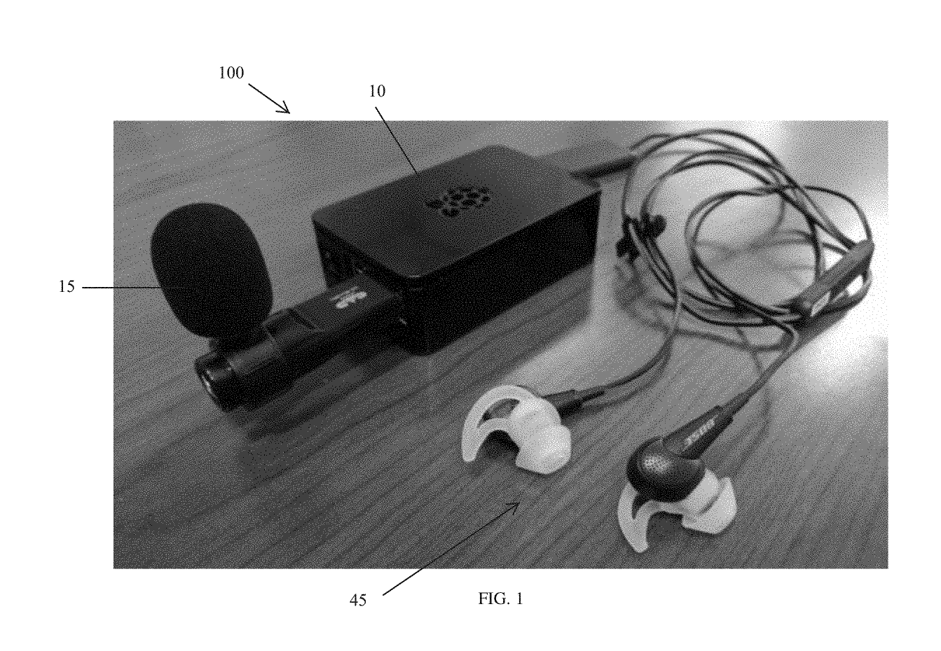

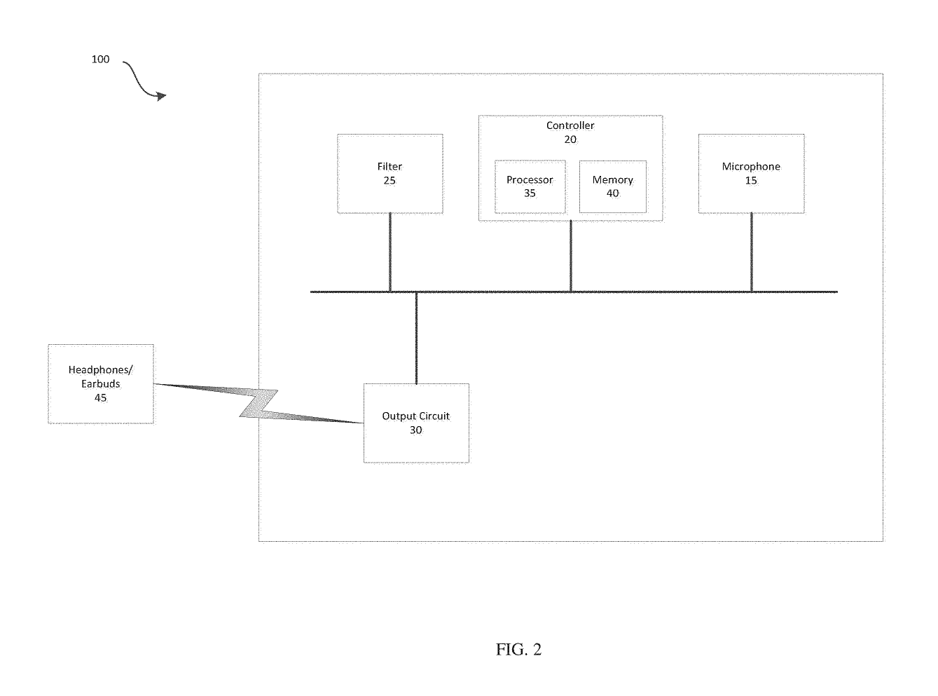

FIG. 1 illustrates a device 100 for frequency-selective silencing of medical device alarms according to one embodiment of the present invention. With reference to FIGS. 1 and 2, the device 100 includes a housing 10, a microphone 15, a controller 20, a filter 25, and an output circuit 30. The controller 20 is electrically connected directly or via a bus to the microphone 15 and the filter 25. The controller 20 includes an electronic processor 35 (e.g., Raspberry Pi (Raspberry Pi Foundation, Cambridge UK)) and a memory 40. The memory 40 includes non-transitory, computer-readable medium, such as random access memory, read-only memory, or a combination thereof. The electronic processor 35 can include a microprocessor configured to execute instructions (e.g., Simulink code) stored in the memory 40. The memory 40 can also store data used with and generated by execution of the instructions.

The controller 20 is configured to receive all incoming environmental sounds detected by the microphone 15. For example, the controller 20 can receive an environmental sound including a plurality of frequencies. The microphone 15 obtains and passes the environmental sound to the controller 20. In other words, the microphone 15 may detect the environmental sound and provide (transmit) the environmental sound to the controller 20. The filter 25 digitally filters the predetermined alarm sound frequencies while letting the other environmental sound frequencies pass. In some embodiments, the controller 20 determines whether a frequency associated with the audible alarm (i.e., a predetermined alarm sound frequency) is included in the plurality of frequencies included in the environmental sound. The controller 20 may determine whether the frequency associated with the audible alarm is included in the plurality of frequencies by performing a spectral analysis on the plurality of frequencies. In response to determining that the frequency associated with the audible alarm is included in the plurality of frequencies, the controller 20 may apply the filter 25 for filtering the frequency associated with the audible alarm to the environmental sound. In other embodiments, the controller 20 continuously applies the filter 25 for filtering the frequency associated with the audible alarm to the environmental sound without first determining whether the plurality of frequencies included in the environmental sound includes the frequency associated with the audible alarm.

The filtered signal (e.g., a filtered version of the environmental sound) is then transmitted to the output circuit 30 and output to the user through passive noise cancelling headphones/earbuds 45. The headphones/earbuds 45 are noise cancelling so that the alarm sound that is present in the environment does not pass through traditional headphones (i.e., non-noise cancelling) and leak into the sound that is heard by the patient. Using noise cancelling headphones/earbuds ensures that only the filtered alarm sound is passed to the patient.

### EXAMPLES

### Example 1—Filtering Alarm Sound

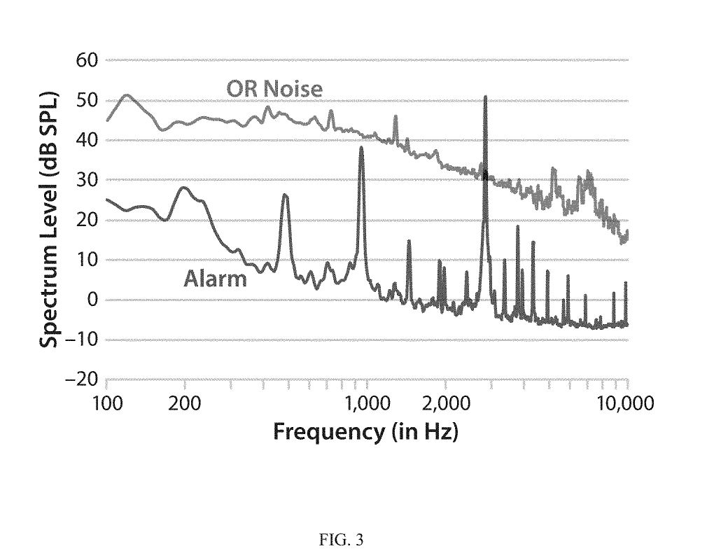

To remove the alarm sound, MATLAB (MathWorks, Natick Mass.) Digital Signal Processing was initially utilized to implement and test several digital filters. This experimental process involved multiple iterations to determine the filter metrics that successfully removed the alarm sounds. A spectral analysis was performed on a single alarm sound to obtain the frequency components of that alarm sound. Then, an Infinite Impulse Response (IIR) Elliptic bandstop filter was created to block the frequency that specifically dominated in the spectral analysis. The width of the stopband was optimized so that the alarm component was completely blocked yet the effect on environmental noise was minimized. The sound file was then filtered by the newly created bandstop filter, and another spectral analysis was performed to determine the next most prominent frequency component. This led to the creation of filters targeting the common red/patient crisis alarm with the most important ones focused at 960 Hz, 1920 Hz, 2880 Hz, and 3840 Hz, as illustrated in FIG. 3. For example, FIG. 3 illustrates the narrow bandwidth peak frequencies (i.e., 960 Hz, 1920 Hz, 2880 Hz, and 3840 Hz) associated with common red/patient crisis alarms. FIG. 3 also illustrates the differences in the spectral analyses of the background noise (i.e., the “OR Noise” signal) and the common red/patient crisis alarms (i.e., the “Alarm” signal).

The dynamic digital filter was then generated in Simulink (MathWorks, Natick, Mass.) using the filter specifications determined in MATLAB. The design is two-fold in that it comprises both a detector (e.g., a controller) and a series of filters. The detector continuously processed all incoming environmental sounds and determined the power present in the unfiltered environmental noise as compared to the power present in the filtered version. When this difference exceeded a predetermined threshold, this served to indicate that an alarm was present in the environment. When the alarm sound was detected, the detector switched on the digital filter, and the filtered version of the noise was transmitted to the patient. This switching mechanism ensured that unnecessary processing and potential distortion did not occur for the patient when no alarms were sounding in the environment. Implementing the detector would further confirm that the patient would not experience ICU-induced psychological problems.

The procedure involved obtaining several recordings of the alarm sound without any background noise. These recordings were used to create and design various filters that eliminated the prevalent frequencies, which comprised the shrill and harsh sound of the alarm. Then, the original alarm sound wave file (.wav) was processed using the created filter and it was shown that the entirety of the alarm was silenced.

Furthermore, another set of recordings were obtained, and these contained the alarm sound with various environmental conditions (for example, television playing in the background, doctors and nurses speaking, presence of pulse oximetry, and the like). These recordings were processed using the same filter mentioned above to show that the sound waves associated with the alarm were entirely removed, while maintaining the integrity and ensuring the passage of all other sounds.

### Example 2

Experimental Design and Testing.

The testing methods were two-fold, subjective and objective. The subjective testing utilized human participants to determine if speech intelligibility was maintained with alarm filtering.

Subjective Testing Background.

The seminal approach for speech intelligibility testing was utilized, as outlined by Lehiste et al. Intelligibility is defined as a property of speech communication involving meaning. The consonant-nucleus-consonant (CNC) paradigm for subjective speech intelligibility testing was utilized. The CNC paradigm presents monosyllabic words to the participants and the experimenter scores each word based on the number of phonemes repeated correctly. A phoneme has little lexical meaning as an unclassified speech event (phonemes are signals, not symbols). The CNC word lists are phonemically and phonetically balanced. As the term “phonetics” is normally used in American linguistics, phonetics concerns the physiological and acoustical properties of speech. The ten CNC lists are composed of 50 words each, representing a selection of 500 words from the total of 1,263 which are refined from the Thorndike and Lorge volume after phonetic/phonemic balancing. As an example, participants were exposed to a monosyllable such as “goose.” The word “goose,” as all monosyllables in the CNC sets, contains three phonemes. The first phoneme, the consonant is a hard “g” (say ‘guh’). The second phoneme, the vowel or nucleus is a prolonged “o” (say ‘ooo’). And, the third phoneme, the second consonant, has a hissing “s” sound. These phonemes were individually scored for each word. If the participant uttered “goose,” the entire word was marked as correct. If the participant uttered “goo” for the word “goose,” the resultant score would be ˜66%, as the first and second phonemes were correct.

Subjective Testing Methods.

Twenty-four (24) participants ranging between 18-22 years of age participated in the subjective testing paradigm. After consent and ensuring normal or corrected to normal hearing, the participants were brought into a simulated ICU setting where they laid down on a bed with a patient monitor alarm stimulus approximately 6 feet above their heads at a 45-degree angle from their head position, similar to an ICU patient monitor location. The speech stimulus was positioned 4 feet above their head and directed towards the unilateral ear as the alarm stimulus. The speech stimulus was positioned as if another person was standing at their bedside and speaking to them. To ensure there was not confounding from the alarm stimulus simply secondary to volume, and based on recently completed work on the negative signal-to-noise ratio in the lab, the alarm stimulus was delivered at 70 dB and the speech stimulus was delivered at 77-79 dB as verified with an Amprobe SM-10 Class II sound level meter (Amprobe, Lynbrook, N.Y.). The participants wore Bose QuietComfort 20i earbuds (Bose, Framingham, Mass.) connected to the device for stimuli exposure. To prevent the subjects from “searching” for the alarm sound in the background noise, they were not told that the device was intended to filter alarm noises but simply asked if they heard alarms throughout their time during the testing and to repeat the CNC word back to the experimenter. The participants were exposed to two randomly selected sets of 50 CNC words. One set had alarm filtering, and the other set had no alarm filtering. The sets of 50 words were purposely different to avoid a learning effect. The study lasted approximately 15 minutes per participant with breaks offered between CNC word sets.

Objective Testing Methods.

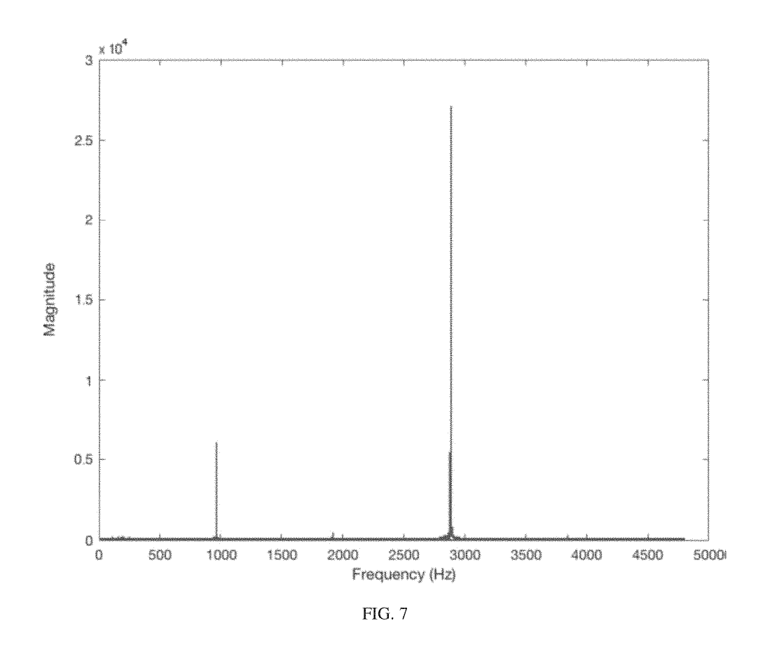

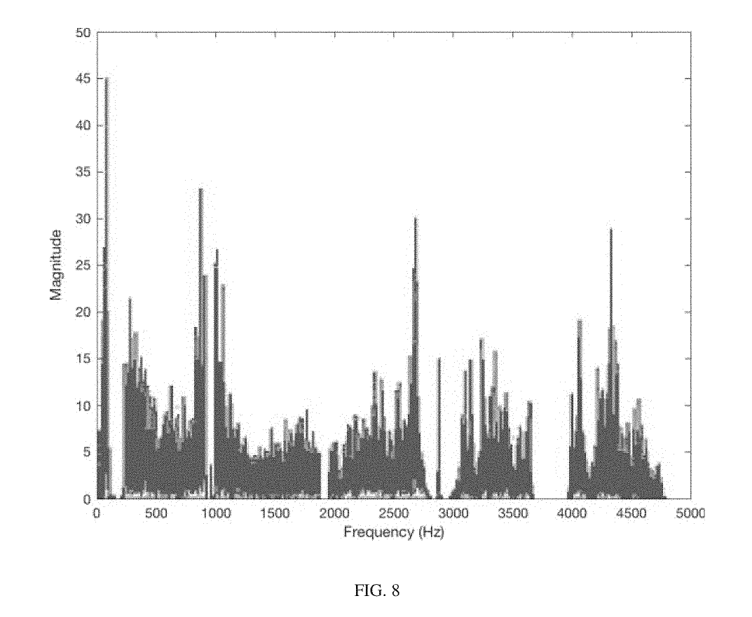

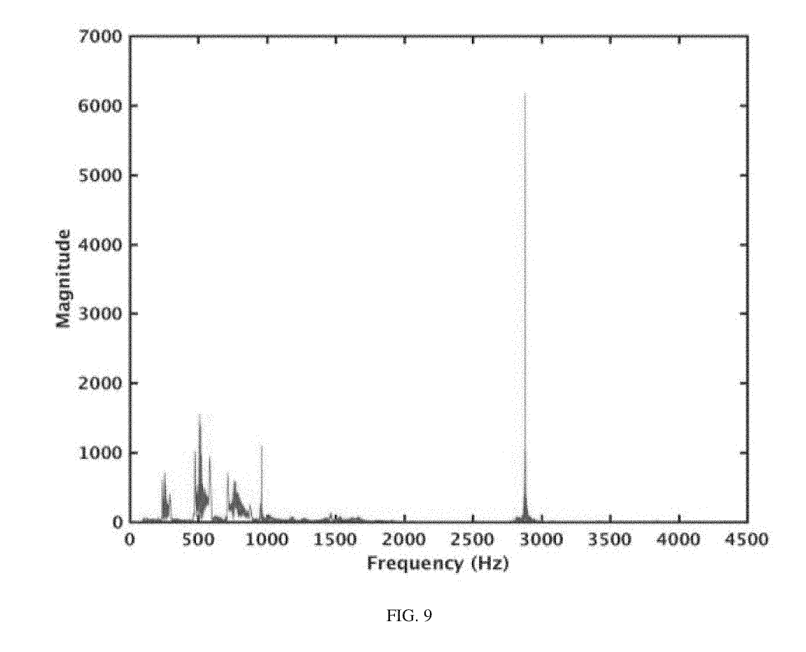

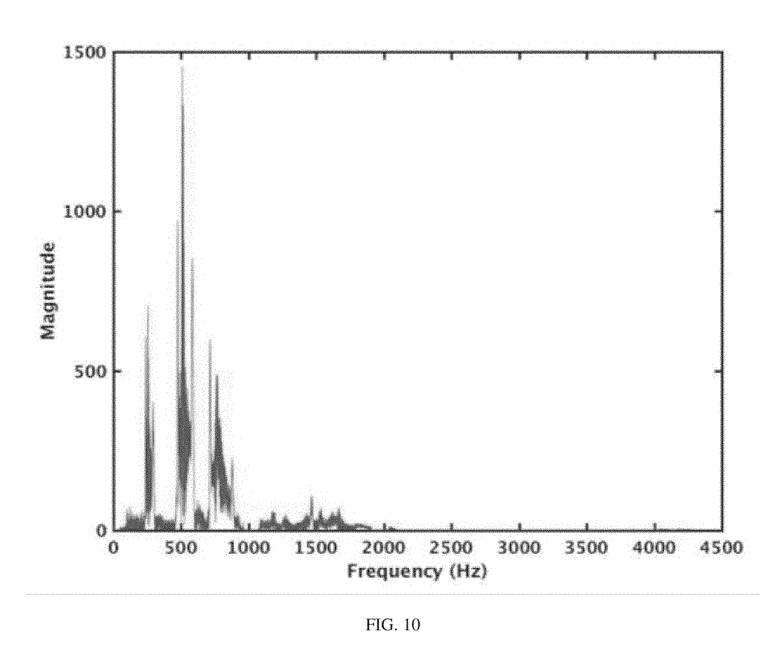

Objectively proving that the device accomplished the project aims, an experiment was performed to demonstrate that the frequency components specific to the alarms were missing from the filtered sound. In the initial stages of the project, a Fast Fourier Transform (FFT) was performed using MATLAB and Simulink on the unfiltered alarm sound sample and the filtered alarm to compare the magnitudes of the frequency components present between the two sounds, as illustrated in FIGS. 7-10. For example, FIG. 7-8 graphically illustrates a FFT of a single unfiltered alarm sound, and FIG. 8 graphically illustrates a FFT of the same alarm sound filtered by a series of bandstop filters. FIG. 9 graphically illustrates a FFT of unfiltered real-time audio output containing speech and alarm sounds, and FIG. 10 graphically illustrates a FFT of unfiltered real-time audio output with speech and filtered alarm sounds

Results.

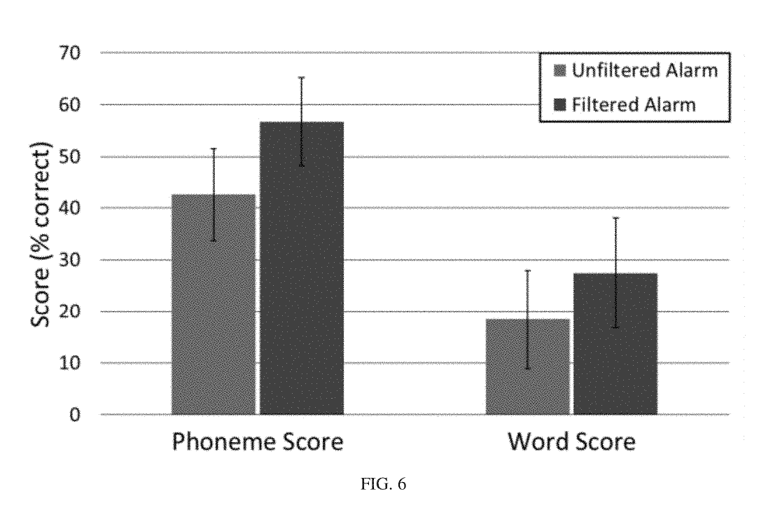

The subjective CNC testing yielded clinically and statistically significant improvement with alarm filtering. For example, as illustrated in FIG. 6, the phoneme score improved from 42.54% (95% CI: 38.96, 46.12) to 56.71% (95% CI: 53.32, 60.10) correct with alarm filtering (p<0.001). The word score improved from 18.42% (95% CI: 14.62, 22.22) to 27.42% (95% CI: 23.17, 31.67) correct with alarm filtering (p<0.01). Additionally, besides these data, the participants endorsed a high-stress state during alarm exposure. In the objective testing using MATLAB, the series of bandstop filters created on MATLAB dampened the magnitudes of the frequencies present in the alarm on the order of 10³, as seen in FIGS. 7 and 8 (note the Y-axis values). Once the filtering on MATLAB proved successful, Simulink (MathWorks) was used to compile the software and deploy the data onto a Raspberry Pi device. By utilizing a file (.wav) with both the alarm sound and environmental noise present, it was proven that the Simulink software could successfully filter the alarm frequencies as shown in FIGS. 9 and 10 (note the Y-axis values).

Expected Patient Benefit.

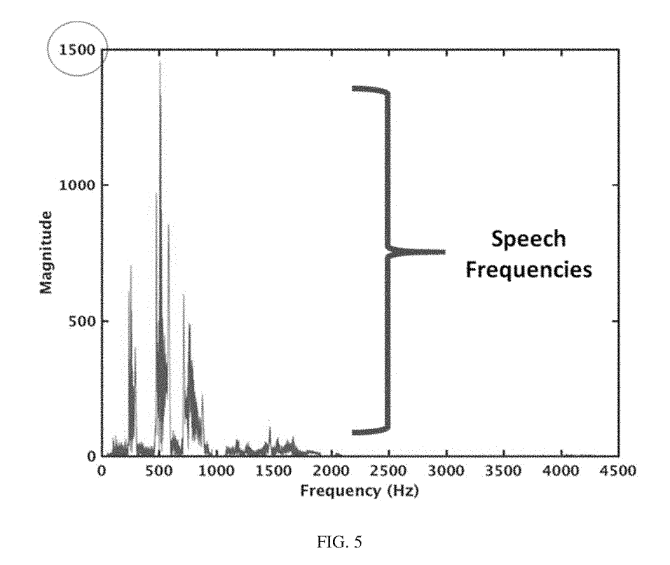

Following the successful implementation of the digital signal processing onto the Raspberry Pi hardware, it is expected that the Raspberry Pi will output an audio signal that will contain the original input audio signal without the alarm-sound frequencies, as illustrated in, for example, FIG. 5. The Raspberry Pi should be able to do real time filtering of audio signals input through the microphone attachment to the Raspberry Pi. Using the switch, the user should be able to hear an output signal of the filtered environmental noise only when the alarm sound is present. Furthermore, the patient should be able to hear an output signal of the original environmental noise when the alarm sound is not present; therefore, not experiencing any distortion of the sound and the only change being the elimination of the alarm frequencies.

Expected Clinician Benefit.

Besides filtering out unnecessary alarms for patients, speech intelligibility will be improved between patients and the healthcare team. This is important during patient and family-centered rounds in the ICU where complex care plans are discussed and the patient must fully understand the risks and benefits of all treatment options before giving consent. Additionally, improving patient satisfaction and minimizing disruptions in the healthcare setting by attenuating the alarm exposure for the patient may further enhance the patient-clinician relationship. In the face of decreased deleterious neuropsychological outcomes for patients, there may be decreased length-of-stay, and improved healthcare economics.

### Example 3

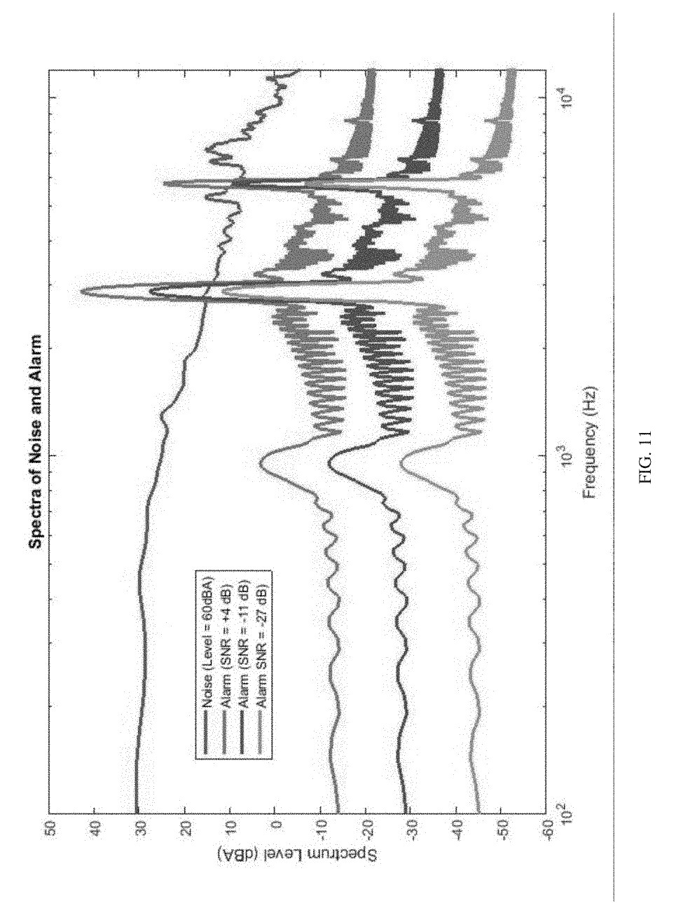

A single auditory alarm signal, the high acuity (red) alarm from a Philips MP-70 patient monitor was utilized in this study. The spectrum of the alarm is shown in FIG. 11. FIG. 11 shows the alarm against a typical background noise level of 60 dB(A), as used in this study, with three different Signal-to-Noise ratios when measuring the overall loudness of the noise and the alarm (rms). It can be seen that most of the frequency components of the alarm are well below the noise level, but that there are two components at about 980 Hz and 2881 Hz which dominate the sound (and will be the only audible components of the sound in any reasonable amount of noise). Thus, the audibility of the alarm depends entirely on these two components. At an SNR (alarm-to-noise) of +4 dB, the alarm should be highly audible, possibly too loud. At −11 dB(A), the spectral comparisons suggest that the alarm should still be audible. At −27 db(A), the alarm should be inaudible.

Using a model of monitoring performance, a paradigm was developed that tasks participants with treating clinical scenarios while also completing domain-relevant auditory and visual tasks to address speech intelligibility and vigilance, respectively. Each perilous situation is associated with an alarm of varying loudness relative to normalized (application of constant amount of gain to bring the peak amplitude to a consistent target level) discipline-relevant hospital background noise.

The study paradigm was refined using 14 attending anesthesiologist participants (10 men and 4 women, 31 to 51 years old) who gave written informed consent as approved by the University Institutional Review Board. Study 1 participants were a different cohort of 31 consenting anesthesiologists, 1 faculty physician (56 years of age) and 30 residents in training 26 to 30 years old, comprising 20 men and 11 women. All study participants had a near-threshold of hearing the alarm from 30 to 38 dB (−30 to −22 dB SNR from ambient background noise).

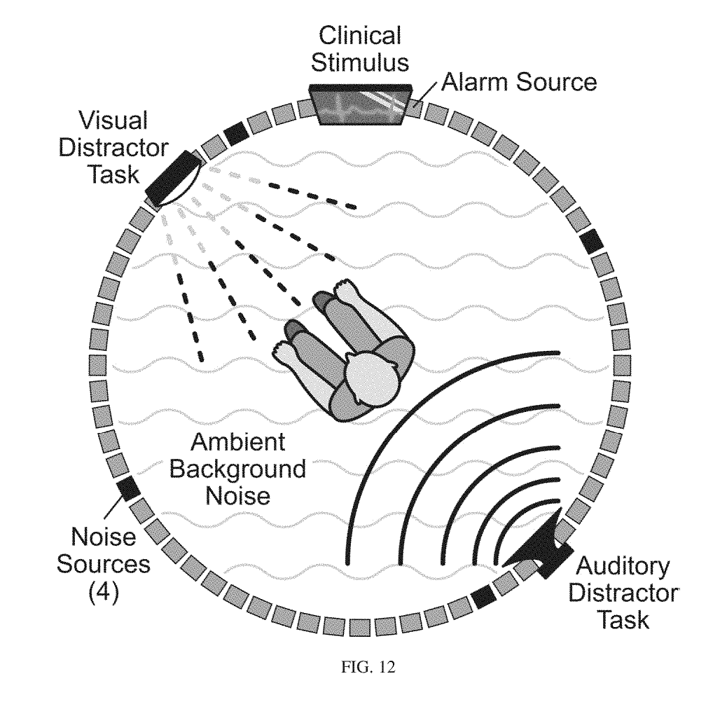

Testing took place in an anechoic chamber (4⋅65×6⋅55×7⋅47 m tall, wire mesh floor 1⋅7 m from bottom). Each participant sat at the center of a circular array of 64 equally spaced loudspeakers (Meyer Sound MM-4), at ear level and 1⋅95 m from the center. The participant faced a central yellow light emitting diode (LED), positioned directly under one of the loudspeakers (FIG. 12). Two additional loudspeakers (JBL 8110) were positioned just above the full loudspeaker array, 15° left and 60° right of the LED. An 18-in color monitor was located 30° to the right of the LED just below the loudspeakers. Sessions were controlled by custom software written in MATLAB (MathWorks, R2015a) on a Dell PC running Windows 7. Sound was generated with two Tucker-Davis Technologies (TDT) RP2 processors linked with 4 TDT PM2 16-channel multiplexers. Additional sound output was through TDT audio components and Crown amplifiers (D-75 and XLS1000). Conveniently mounted on the arm of the chair at which each participant sat was a customized computer keyboard that supported the specific study tasks as described below.

Throughout the session, pre-recorded discipline-relevant background noise from an intensive care unit was played continuously through the two JBL auxiliary loudspeakers and two ring speakers (located 15° and 105° left, and 60° and 150° right of the participant's facing direction). A sound level of 60 dB was chosen based on the literature, preliminary acoustic measurements in our actual intensive care units, and pilot testing in the anechoic chamber. An average spectrum of 29 seconds of the noise is shown in FIG. 11, sampled at 24,414 Hz. There was little variation in that spectrum over time, and it averaged around 60 dB(A) for the duration of the study.

The participant was instructed to engage in three interleaved or concurrent tasks (FIG. 12). The primary task was monitoring for emergency events. The two secondary tasks were responding to spoken phrases from the validated Coordinate Response Measure (CRM) and responding to the illumination of a yellow LED, which was construed as an unspecified but critical signal. The alarm monitoring task simulated a typical domain-relevant patient monitoring system, with the visual display showing physiological values (diastolic and systolic blood pressure, heart rate, respiration rate, and blood oxygen level, refreshed at 1 Hz) representing the different ‘patient’ conditions. The vital signs varied randomly within the ‘normal’ range except during the four simulated emergency events—isolated sinus bradycardia (low heart rate), isolated tachycardia (high heart rate), tachycardia with hypotension (low blood pressure), and bradycardia with hypotension (Table 1). Each event was accompanied by the same audible alarm signal, projected from a loudspeaker directly above the visual display, presented at different variable sound levels, calculated as different signal-to-noise ratios (SNRs) compared to the ongoing hospital background noise. The participant was expected to ‘treat’ each emergency event using one of four labelled keys on the keyboard, corresponding to different appropriate drug choices (atropine, esmolol, phenylephrine, and ephedrine, respectively).

The CRM task measures speech intelligibility ability, which is the foundation for communicating in any complex multi-member team-based endeavour. The CRM corpus has gained broad acceptance as a research tool for investigating speech intelligibility in background competition and has been widely used in studies of informational masking. The CRM has been used in studies in which speech is masked by speech because the format of the speech materials allows the listener to lock onto a target phrase signified by its call sign even when competing sentences from the same corpus are presented simultaneously. Choosing two or more talkers results in speech-shaped noise versus a single-talker interferer yielding a non-monotonic psychometric function. The salient features of the CRM for this study were based on previous work by Eddins et al. and Bolia et al. as well as parallels to real-life clinical scenarios. The clinical correlation, besides the clinical task, was that speech intelligibility is paramount in clinical situations in emergency and non-emergency situations in practice locations such as the operating room and intensive care unit. Given that, the two-talker CRM paradigm in previous work was followed instead of four-talker babble or cafeteria noise (remembering that background hospital noise was utilized to simulate the intended environment). The CRM task consisted of pre-recorded spoken sentences with the carrier phrase, “Ready [call sign], go to [color] [number] now” (e.g. “Ready Baron, go to blue eight now”). In this study, three phrases were presented concurrently from a single loudspeaker located behind the participant, each with different call signs, colors, and numbers spoken by three different males. The full CRM phrase set consists of 256 combinations of eight call signs, four colors, and the number 1 through 8. The sound level of each CRM phrase was 0 dB relative to the background hospital noise level. One of the three enunciated phrases always used the call sign “Baron.” The participant was instructed to report the color and number of the phrase that had that designated call sign using clearly marked buttons on the keyboard. The participant received visual feedback via brief flashes of centrally located LED's—green for correct selection of both color and number or amber if either were incorrect.

The visual distraction task was structured as a classical vigilance response task in which the participant was to press a designated key press whenever the LED light went off. Once lit, the yellow LED remained on for a variable time (M=5 s, SD=2 s, minimum 1 s). After turning off, it remained off until the participant pressed the key. To discourage participants from tapping the vigilance key randomly in an effort to keep it on, the LED was switched off if the key was pressed while the LED was on. One purpose of this task was to prevent participants from directing their visual attention continuously to the vital signs monitor, better emulating real-world clinical conditions.

For each participant, all twenty combinations of four types of emergency events (specified above) and five alarm levels were presented. Auditory alarms were presented at each participant's individual threshold (between −30 dB and −21 dB), −20 dB, −11 dB, −2 dB, and +4 dB) relative to hospital background noise at 60 dB.

There were ten trials per condition. The 200 trials were sequenced in 10 blocks of 20 trials each; with each block containing a random ordering of the 20 combinations of four emergency types and five alarms levels. Although the session was structured by “trials,” these were connected seamlessly so that participants experienced a single running event sequence lasting approximately 70 minutes, with breaks offered every 15 minutes. Trial duration averaged 20 s (SD=5 s, range 12 s to 28 s), during which there were two CRM presentations and one emergency event. All emergency events lasted 6s, and were constrained to begin at least 2 s after trial onset and end at least 2 s before trial offset. CRM presentations began at least 1 s after trial onset and ended is before trial offset. At least 2.5 s elapsed from the end of the 1 first CRM presentation to the start of the next. Aside from these constraints, the timing of the emergency events and CRM presentations was random. The LED vigilance light was on at the very beginning of the study, and then went on or off as described above, without regard for trial boundaries. Therefore, CRM presentations and LED vigilance events overlapped with some but not all emergency events.

Data Analysis

A. Primary Task—Alarm Monitoring and Treatment Selection

For each participant, and for each combination of alarm condition and co-occurrence of a CRM and vigilance task, inverse efficiency scores (IES) were calculated as the ratio of the average response time relative to the fraction of correctly addressed primary tasks. Lower IES scores represent better performance. The inverse efficiency score was initially introduced as a measure of approximate number system (ANS) acuity, and is calculated by diving the mean response time (RT) of correct responses by the proportion of correct responses. The IES is used primarily to account for a speed-accuracy trade-off (e.g., accuracy can often be improved at the expense of response time and vice versa). In addition, the IES has an intuitive interpretation as the average amount of time required to achieve a correct response in a sequence of consecutive trials (i.e. the smaller the efficiency score, the higher the ANS acuity).

Linear and logistic mixed effects regression analysis were used to quantify the effect of alarm signal-to-noise ratio (SNR) on the amount of time required to respond to a clinical task (alarm event), the odds of selecting a correct response to the clinical event presented, and the corresponding IES, adjusting for the possibility of concurrent CRM or vigilance task distractions. Due to skew in the distribution of response time and IES, these variables were log-transformed prior to regression analysis. A three-knot natural spline was used to model the effect of alarm SNR. The “no association” null hypothesis regarding alarm SNR was assessed using a Wald-type chunk test. Pairwise interactions between alarm SNR and the co-occurrence of either distracting task (CRM, vigilance) were also considered. Interactions were retained when there was strong evidence, as determined by a likelihood ratio test. A random intercept indexed by study subject was used to account for heterogeneity among participants (e.g., some participants were consistently quicker to respond than others, regardless of alarm level). The effects of alarm SNR were summarized using pointwise bootstrap (normal approximation) 95% confidence bands, and stratified by CRM co-occurrence. The effects of CRM or vigilance task co-occurrence were summarized using Wald-type 95% confidence intervals and tests for the mean difference and odds ratio (OR). P values less than 0.05 were considered statistically significant. Thus, the type-I error rate was preserved at 5%.

B. Secondary Task—CRM

Linear and logistic mixed effects regression analysis were used to quantify the effect of alarm SNR on the average amount of time required to respond to a CRM task and the odds of selecting the correct response, adjusting for the concurrence of an unaddressed clinical task (i.e. with alarm), alarm SNR (if alarm was concurrent), and concurrence of a vigilance task. No interactions were considered. These analyses were otherwise treated similarly to those for the clinical task.

Results

A. Primary Task—Alarm Monitoring and Treatment Selection

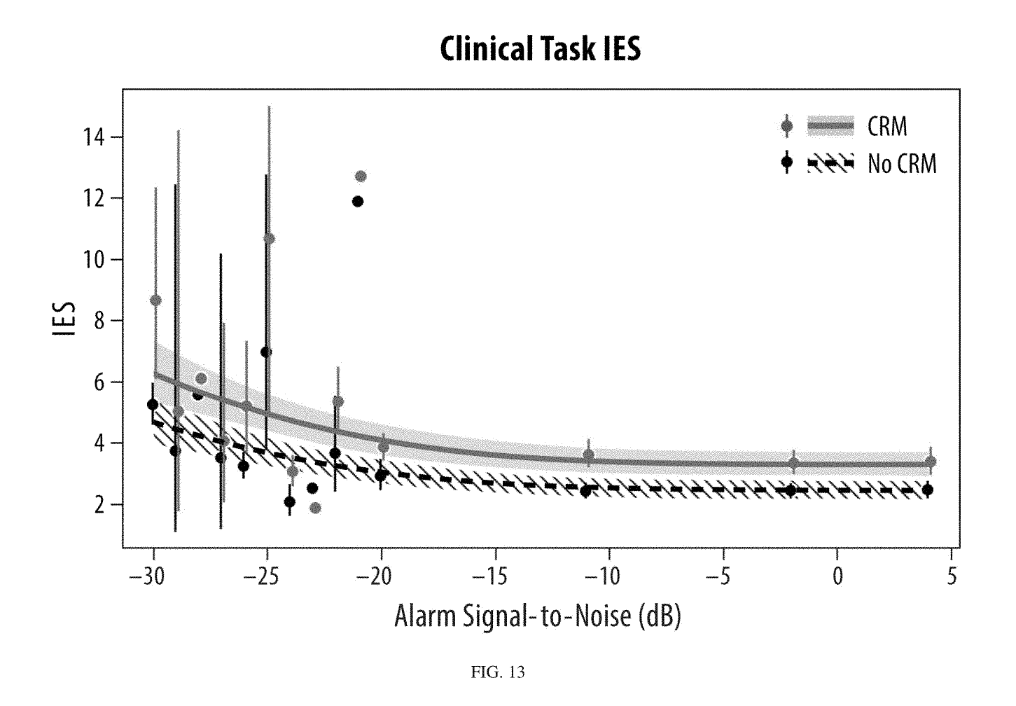

Among the 31 study participants, 25 completed all 200 trials, 3 completed 160, and 1 each completed 180, 140, and 120 trials. Across all trials, 51% of alarm tasks were addressed without interruption by a CRM or vigilance task, 24% were interrupted by CRM task, 15% by a vigilance task, and 10% by both a CRM and vigilance task. Table 2 summarizes participant performance on the alarm monitoring task, stratified by alarm SNR. The associations between alarm SNR and primary task performance were statistically significant—both the accuracy and speed of the treatment choices, and the corresponding inverse efficiency score, were significantly improved at sound levels greater than the near-threshold of hearing (Table 3). FIG. 13 illustrates the associations between alarm SNR and the primary task IES. This shows that there was little difference in performance on the primary task when the alarm sound was −11 dB below background noise as compared with +4 dB above background noise. Specifically, the estimated probability of correctly addressing the primary task when there was no concurrent distracting task was only 0.7% smaller at −11 dB relative to +4 dB (risk ratio 95% CI: 0⋅98, 1⋅02). Likewise, the estimated mean response time was just 0⋅04 s longer (95% CI: −0⋅03, 0⋅12), and the estimated mean IES was 0.04 s longer at −11 dB versus+4 dB (95% CI: −0⋅04, 0⋅12), when there was no concurrent distracting task. Thus, provided the alarm signal was audible (as FIG. 11 suggests it would be at −11 dB), performance was no further enhanced by increasing its loudness.

Concurrent presentation of the secondary auditory CRM task significantly degraded performance. The odds of correctly addressing the primary task were decreased by 29% (95% CI: 16, 39), mean response time was slower (0.79 s, 95% CI: 0⋅73 s, 0⋅84 s), and mean IES was longer (0⋅30 s, 95% CI: 0⋅24 s, 0⋅35 s). In contrast, concurrent presentation of the visual secondary task (a visual vigilance task) did not significantly affect primary task performance, nor were there any significant interactions.

B. Secondary Task—CRM

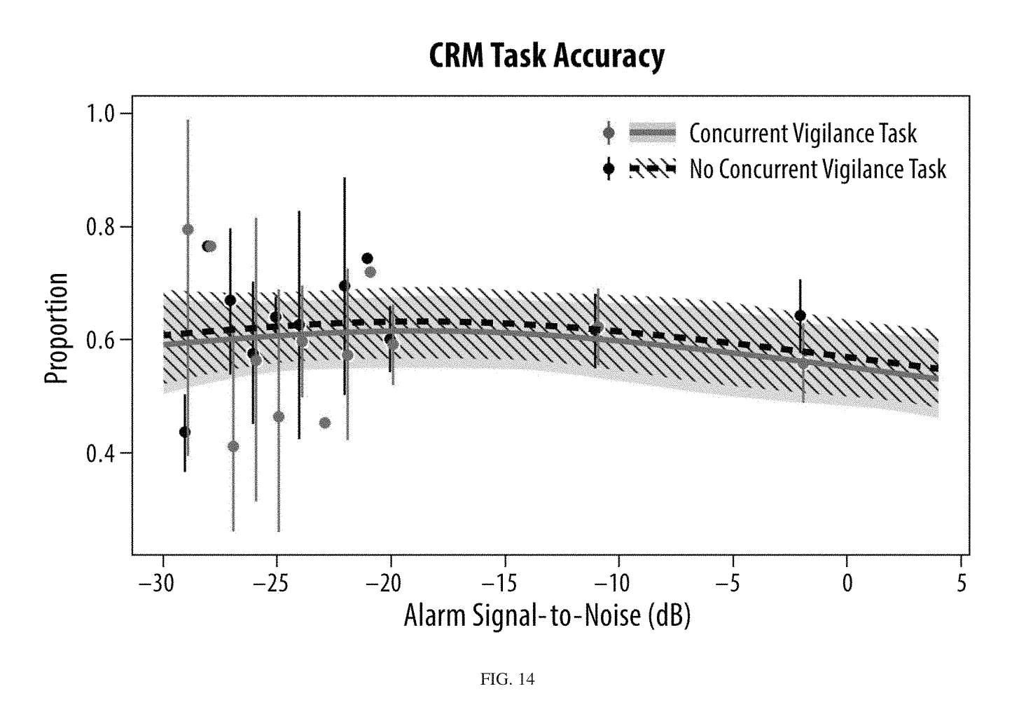

The likelihood of correctly addressing the CRM task was not significantly decreased when there was a concurrent secondary vigilance task (OR: 0⋅93; 95% CI: 0⋅85, 1⋅03). However, alarm loudness (when there was a concurrent primary task) significantly affected the likelihood of correctly addressing the CRM task (p=0⋅002; Table 3). FIG. 14 illustrates the association between CRM task accuracy with concurrent clinical task alarm level. The positive alarm SNR (i.e., conventional levels) condition was associated with the poorest CRM performance under these conditions. In addition, the estimated probability of correctly addressing the CRM task was 12% greater at −11 dB versus+4 dB (95% CI: 2, 24). Thus, the higher, positive alarm SNR was associated with poorer performance relative to lower SNRs, suggesting that the higher alarm loudness level impeded, rather than helped, performance on the CRM task.

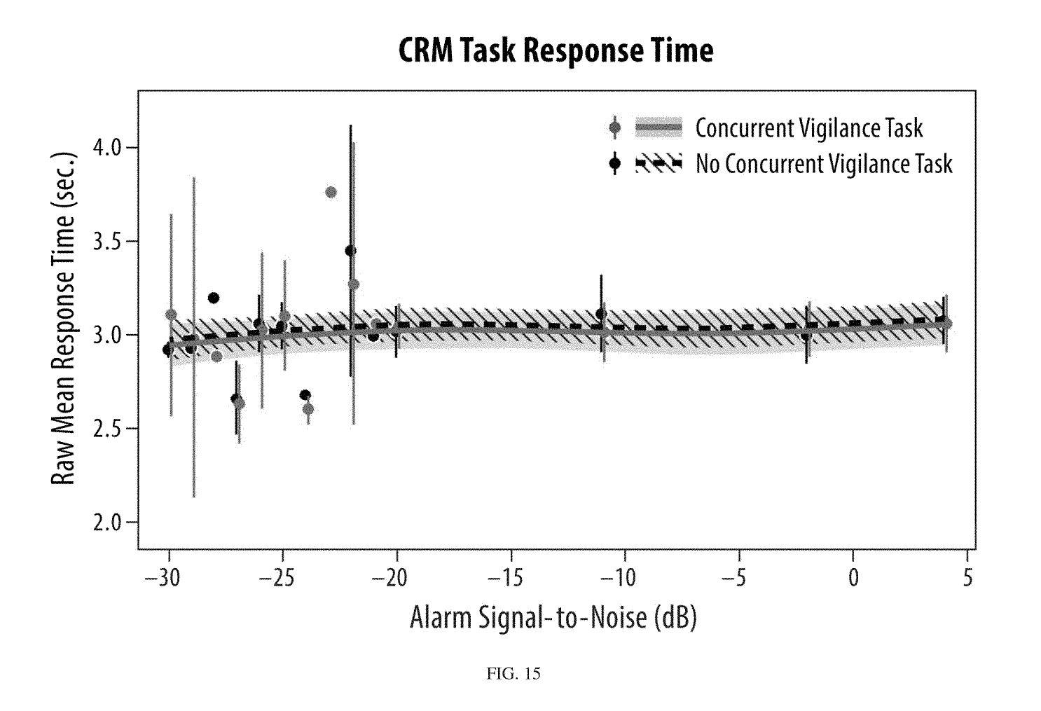

Neither the co-occurrence of a primary task nor the associated alarm SNR were significantly associated with CRM task response time (FIG. 15). The co-occurrence of a vigilance task did not significantly affect CRM response time.

### DISCUSSION

A. Acoustics and Alarm Design

A new experimental paradigm modeled on the types of tasks an anesthesiologist might be expected to perform while monitoring auditory alarm signals was described to study the effects of alarms on human performance. Primarily, we question the typical approach and understanding of the signal-to-noise ratios of auditory alarm signals and background noise and how the levels of auditory alarms should be set. Using medical alarms and the performance of anesthesiologists as a model, the results of this study demonstrate that auditory alarms do not need to be louder overall than background sound levels to elicit accurate and reliable responses. Specifically, both response time and accuracy of the treatment selection to an abnormal clinical condition was preserved from 4 dB louder to 11 dB softer than the 60 dB of background noise. The presence of the secondary auditory (CRM) task adversely affected both response time and response accuracy, but appeared to do so in a comparable manner across SNR levels. Further, CRM task accuracy degraded when alarm sounds were +4 dB above background levels suggesting an interfering effect on the speech perception task at alarm sound levels typical of real-world conditions.

Giving context of our CRM results to other work, Eddins demonstrated that performance on this paradigm at 0 dB SNR yielded about a 55% correct response rate. The addition of feedback in the paradigm was to ensure attentional allocation and drive to perform in a competitive cohort of clinicians. The alarm stimulus, not interfering with human speech, would not appreciably mask the target talker. Thus, a slightly higher performance data and approach is informed by previous work utilizing the CRM, the nature of the paradigm, and pilot work showing that approximately 65% performance with feedback strikes a balance of attentional allocation with the desire to improve without hitting a performance a ceiling or conversely eliciting frustration and burnout from the task.

As FIG. 11 suggests, the auditory alarm signal was audible at −11 dB SNR, as one of the frequency components was still well above threshold at that frequency. Below this SNR, both components became inaudible. At an SNR of +4 dB, the most prominent component of the alarm was about 30 dB above threshold at that frequency, which according to Patterson (1982) would be so loud as to interfere with task performance. This does seem to be the case here, where the secondary CRM task was impeded at this higher level (though the effect may also be partially due to masking by the alarm signal). The results suggest that the solution to setting this particular alarm at an appropriate level would be re-calibrate the relationship between the alarm signal and the background noise so that audibility is deemed to have started at an SNR of −11 dB, and that a positive SNR is simply too loud.

The findings for this study are to some extent specific to the alarm tested because it has a particular spectrum and will thus represent a specific relationship between the noise background and the components of that alarm sound. However, the alarm used is fairly typical of alarms often used in medical equipment in that it relies on one or two relatively high frequency, loud components for its audibility, rather than a balanced spectrum with more, but more appropriate, components. Other alarms with different spectra may produce slightly different results depending on how the energy of the sound is distributed across its spectrum. This is a topic that could be modeled or tested in future studies. Nevertheless, what this alarm demonstrates is the gaping mismatch between evidence-based recommendations about how the spectrum of an alarm sound should be designed and set in relation to possible background noise scenarios. In practice, our findings suggest that alarms can be set at the minimum or near-1 minimum audible level, which can be determined through a simple listening test.

The data also demonstrate that ‘louder is not better’. For the primary task, provided the alarm is audible, there is no benefit to increasing audibility to performance on the primary task. Thus, auditory alarms can be set at minimum levels of audibility with no detriment to performance. Indeed, the results of the secondary task performance suggest that louder is worse, as performance on the secondary task declines as alarm audibility is increased—though whether this is a direct masking effect or is some function of the participants being overloaded by the tasks, as it is well known that increased noise reduces performance in high workload scenarios.

This effect of alarms at typical volumes on other auditory tasks may be due to divided auditory attention and/or auditory masking. In high-consequence industries, where team communication can be paramount, worsening of speech perception and errors of interpretation may lead to deleterious consequences.

B. Clinical Correlates of Auditory Medical Alarms

Medical intervention is necessary to improve patient health, but so is “therapeutic neglect”—letting patients rest is part of the recovery process. Perceived sound loudness and measured sound loudness are not equivalent, White et al. describe that nurses perceive noise to be 14.1 dB higher than the actual noise level at the nursing station, and 9.3 dB greater than the noise between patient rooms. As there is a difference in perceived and measured sound, initial work completed by Buxton and colleagues parsed the sound sources contributing to the overall sound level exposure, measuring sleep via polysomnography in a sleep laboratory. Buxton found that alarms at 70 dBA caused arousal in 100% of subjects in non-rapid eye movement (NREM) stage N2 sleep, and conversational speech produced a 50% arousal rate at just 50 dBA in both N2 and REM sleep. Besides the measurable aspects of patient care, such as sleep, patient perception of care is also crucial. In a survey of ICU patients, 40% recalled ICU noise and 85% reported being disturbed by it. Attenuating the disturbing aspects of the acoustic environment, interventions to create a softer acoustic environment may create a restorative period—defined as a minimum of five minutes with the maximum noise level over a period of time limited to 55 dB and the raw noise (the minute-to-minute peak values reached by sound pressure levels) limited to 75 dB. Quiet time creates a restorative period, a period when sound is at a level less likely to cause arousal. But does trying to increase currently modifiable sources of noise truly help?

Recommendations for quiet time have existed for over 20 years. Since patient monitor alarms cannot yet be turned down (only silenced), these interventions typically include restricting or limiting visitors, staff movement, treatments, closing doors or curtains, and decreasing noise and light. Gardner et al. found that quiet time led to a 10.3 dB difference between units and improved sleep; however, sound levels quickly returned to baseline within 30 minutes of the conclusion or quiet time. Although this is encouraging, the quiet time interventions still did not achieve the WHO noise recommendations. A missing piece of the puzzle is the newfound knowledge presented in this study, it is safe to turn down the alarms and achieve the recommended WHO noise recommendations.

The ICU nurse typically manages two critically ill patients, with attention allocation split between two patients and two patient rooms. The higher acuity patient may have more monitoring devices and more alarms. Lawson et al. found that turning up the alarms on the infusion pumps simply increased the sound level exposure in that patient's room, but not in the adjacent room where the nurse may be attending to his other patient. The use of earplugs to diminish the effect of alarms on the patient may improve sleep, but the potential detrimental effects of decreasing all environmental auditory stimuli on neuropsychological outcomes such as ICU delirium has not been elucidated.

Improving the alarmscape in the ICU will likely improve patient sleep, but sleep is not the only marker of improvement for patients and clinicians—as utilizing sleep as a primary outcome (as observed in clinical medicine, outside of a sleep lab) is fraught with using different evaluation methods, and over/under estimation of the quality of sleep. However, Sveinsson et al. found that sleep deprivation is a potential precipitating factor for delirium in cardiac surgical patients, and Helton et al. found that patients with sleep deprivation were significantly more likely to develop delirium than patients without sleep deprivation. There is a feedforward mechanism between sleep deprivation and delirium admixed with ICU environment factors (noise, light, circadian disruption, patient care activities, stress and sensory deprivation), stress response (critical illness, mechanical ventilation, pain, sepsis), and direct effects on the brain (medications, dementia, sepsis, head trauma, advanced age, alcoholism). It is no longer good enough to discharge patients from the ICU alive, hospitals must be mindful of neuropsychological outcomes such as ICU delirium and PTSD anchored to critical illness, and what we can do to modify and ameliorate those negative outcomes. A meta-analysis from 1997-2012 shows the prevalence of acute psychological risk factors for PTSD range from 8-27%. Clinical risk factors include use of benzodiazepines, duration of sedation, and mechanical ventilation. Psychological risk factors include stress and fear experienced acutely in the ICU, and frightening memories of the admission. As described earlier, Hofhuis et al. exhibited that patients remember and are disturbed by the ICU alarmscape.

The work presented herein shows that alarm volume should be dynamic, it is safe to turn down the volume to improve patient safety. Sound is a complex signal and the acoustic features of sound must be dissected and studied before coalescing into an auditory unisensory stream and then with multisensory information. Through a rigorous approach based in neuroscience and human factors applications, this work serves as a foundation to improve alarm design and patient care.

One of the key finding of this study was that primary task performance was maintained even when alarm volume was noticeably lower than background sound levels. The results suggest that it may be safe to decrease alarm volumes in operational settings. Sound is a complex signal and past problems with auditory alarms are partially attributable to the inability to appreciate this complexity. This study provides new experimental evidence to inform alarm management strategies to optimize the design of auditory alarms, particularly in high-tempo, high consequence situations. This approach serves as a foundation for parsing the sound signal, starting with the signal-to-noise ratio, to improve the use of auditory alarms across many applications to enhance human performance and health.

The device relies on the use of noise-cancelling headphones to transmit the filtered sound to the patient. The device can incorporate a wireless, in-ear device that may perform all the necessary filtering functions and transmission of the filtered sound in the device itself. Additionally, while the experiment described above focused on eliminating offending frequencies from just one common alarm, the device can be programmed to eliminate such frequencies from a plurality of alarms, for example, if the patient were connected to several monitors each with their own alarm. With respect to the overarching problem of audible medical alarms, the device serves as an interim solution that may solve the patient problems of PTSD, delirium, and general patient discomfort. However, the physician-related problems still remain. Another in-ear device, according to an embodiment, can transmit alarms and patient information directly from the patient monitors and equipment in the patient room to the physician or nurse at the optimal signal-to-noise ratio. This device would suppress the need to have audible free-field medical alarms. The patient specific device described herein would remain necessary in the likely slow transition to, or absence of complete global adoption of healthcare provider in-ear monitoring devices.

Audible medical alarms are the cause of myriad hazards in hospital and ICU settings. Their shrill acoustic features and the frequency at which they alarm (both in sheer number and frequency spectrum) are responsible for many negative consequences, especially for patients. Patients may experience PTSD and delirium secondary to sleep disturbance from alarms and healthcare providers' divided and diminished attentional resources allocated to alarms. The frequency-selective silencing device was created to alleviate these problems and create a more comfortable environment for the patients during their length of stay in the ICU. The device has been demonstrated to successfully remove alarm sounds while avoiding audible distortion of speech and other environmental noise, and should the device be widely implemented in hospital setting, the device will prevent patients from hearing the disturbing and potentially harmful sounds of free-field medical alarms and may improve patient safety.

Thus, embodiments described herein provide, among other things, a frequency-selective silencing device for digital filtering of audible medical alarm sounds. Various features and advantages of the invention are set forth in the following claims.

What is claimed is:

1. A frequency-selective silencing device for digital filtering of an audible medical alarm, the device comprising:
a microphone configured to detect environmental sound;
a frequency filter; and
a controller in communication with the microphone and the frequency filter, the controller configured to
receive the environmental sound including a plurality of frequencies,
determine whether a frequency associated with the audible medical alarm is one of the plurality of frequencies in the environmental sound,
apply the filter for filtering the frequency associated with the audible medical alarm to the environmental sound, and
output a filtered version of the environmental sound to a user.

2. The device of claim 1, wherein the filtered version of the environmental sound is the environmental sound without the frequency associated with the audible medical alarm.

3. The device of claim 1, further comprising a microphone configured to detect the environmental sound and provide the environmental sound to the controller.

4. The device of claim 1, further comprising passive noise cancelling earbuds, wherein the device outputs the filtered version of the environmental sound to the user via the passive noise cancelling earbuds.

5. The device of claim 1, wherein the controller is further configured to
determine whether the frequency associated with the audible medical alarm is included in the plurality of frequencies, and
apply the filter for filtering the frequency associated with the audible medical alarm to the environmental sound in response to determining the frequency associated with the audible medical alarm is included in the plurality of frequencies.

6. The device of claim 5, wherein the controller is further configured to output an unfiltered version of the environmental sound to the user in response to determining that the frequency associated with the audible medical alarm is not included in the plurality of frequencies.

7. The device of claim 1, wherein the controller is configured to determine whether the frequency associated with the audible medial alarm is included in the plurality of frequencies by performing a spectral analysis on the plurality of frequencies included in the environmental sound.

8. The device of claim 1, wherein the filter is configured to filter a second frequency associated with a second audible medical alarm different from the first audible medical alarm.

9. The device of claim 8, wherein the controller is further configured to
determine whether the second frequency associated with the second audible medical alarm is included in the plurality of frequencies,
in response to determining that the second frequency associated with the second audible medical alarm is included in the plurality of frequencies, apply the filter for filtering the second frequency associated with the second audible medical alarm to the environmental sound.

10. A method for silencing an audible medical alarm with a frequency-selective silencing device for digital filtering of the audible medical alarm, the method comprising:
detecting an environmental sound including a plurality of frequencies;
determining whether the frequency associated with the audible medical alarm is included in the plurality of frequencies;
in response to determining that the frequency associated with the audible medical alarm is included in the plurality of frequencies, applying a filter to filter the frequency associated with the audible medical alarm to the environmental sound; and
outputting a filtered version of the environmental sound to a user.

11. The method of claim 10, wherein the filtered version of the environmental sound is the environmental sound without the frequency associated with the audible medical alarm.

12. The method of claim 10, wherein outputting the filtered version of the environmental sound includes providing the filtered version of the environmental sound to the user via passive noise cancelling earbuds.

13. The method of claim 10, further comprising
determining whether the frequency associated with the audible medical alarm is included in the plurality of frequencies, and
applying the filter for filtering the frequency associated with the audible medical alarm to the environmental sound in response to determining the frequency associated with the audible medical alarm is included in the plurality of frequencies.

14. The method of claim 13, further comprising outputting an unfiltered version of the environmental sound to the user in response to determining that the frequency associated with the audible medical alarm is not included in the plurality of frequencies.

15. The method of claim 10, further comprising determining whether the frequency associated with the audible medial alarm is included in the plurality of frequencies by performing a spectral analysis on the plurality of frequencies included in the environmental sound.

16. The method of claim 10, further comprising applying the filter to filter a second frequency associated with a second audible medical alarm different from the first audible medical alarm.

17. The method of claim 16, further comprising
determining whether the second frequency associated with the second audible medical alarm is included in the plurality of frequencies,
in response to determining that the second frequency associated with the second audible medical alarm is included in the plurality of frequencies, applying the filter for filtering the second frequency associated with the second audible medical alarm to the environmental sound.
